(19) United States
(12) Patent Application Publication
(10) Pub. No.: US 2010/0011221 A1
(43) Pub. Date: Jan. 14, 2010

(54) Secured storage device with two-stage symmetric-key algorithm

(76) Inventors: Ming-Shen Lin, Hsinchu (TW); Chih-Nan YEN, Hsinchu (TW); Fu-Ja Shone, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,059

(22) Filed: Nov. 12, 2008

(30) Foreign Application Priority Data
Jul. 10, 2008 (TW) 097126182

(51) Int. Cl. H04L 9/32; H04L 9/06; G06F 12/14

(52) U.S. Cl. 713/183; 380/277; 713/189

(57) ABSTRACT

A secured storage device uses a user key set by user to encrypt a primary key that is for encryption or decryption of user data, to produce a first encrypted data. In the secured storage device, neither the primary key nor the user key is stored, but the first encrypted data, and a secondary key and a second encrypted data produced from the secondary key encrypted with the user key for verifying the password inputted by user are stored. Therefore, even though a storage medium in the secured storage device is detached and read, the primary key and the user key cannot be obtained by a third party for reading out any encrypted user data from the secured storage device.

### FIELD OF THE INVENTION

The present invention is related generally to secured storage devices and, more particularly, to a secured storage device with symmetric-key algorithm.

### BACKGROUND OF THE INVENTION

In cryptography, encryption and decryption algorithms may be classified into symmetric-key algorithms and asymmetric-key algorithms. A symmetric-key algorithm employs only a single key, or two keys that are easily derivable from each another, for data encryption and decryption. For example, for a universal serial bus (USB) storage device with symmetric-key algorithm, the encryption/decryption mechanism may be intuitively designed so that a key is kept by user and a key identical to the former one is stored in the USB storage device for verifying whether a key inputted by user is identical to the previously stored key (meaning the key inputted by the user is correct) and for encrypting and decrypting user data. FIG. 1 is a diagram to illustrate the basic concept of symmetric-key algorithms. For data storage, a key 12 set by user is employed to encrypt a raw data 10 to produce an encrypted data 14. For data read-out, the same key 12 previously stored in the USB storage device is employed to decrypt the encrypted data 14 to retrieve the raw data 10. However, this approach is very risky because the key 12 is directly stored in the USB storage device, for instance, in a flash memory of the USB storage device. Once the flash memory storing the key 12 is detached from the USB storage device and invaded, the key 12 can be easily cracked by a third party, resulting in total loss of security in writing and reading data into and from the USB storage device.

Differently, an asymmetric-key algorithm employs two different keys for data encryption and decryption, respectively. For example, for a USB storage device with asymmetric-key algorithm, the user holds a private key and a public key. The private key is used to decrypt user data and the public key serves to verify a key inputted by user and to encrypt user data. The USB storage device only stores the public key and thus, in the event that the public key in the USB storage device is maliciously cracked, the USB storage device only allows data to be written thereinto, while the encrypted data in the USB storage remains secured as long as the private key, which is necessary for decryption, is safely kept by the user. Therefore, asymmetric-key algorithms are advantageous in providing better security. While symmetric-key algorithms are inferior in security, benefits thereof include promptness in processing and economy of hardware resources. Thus, symmetric-key algorithms nevertheless stand on a vantage point in practical applications.

Therefore, it is desired a storage device with high security implemented by symmetric-key algorithm.

### SUMMARY OF THE INVENTION

An object of the present invention is to provide a secured storage device with two-stage symmetric-key algorithm.

According to the present invention, a secured storage device uses a user key set by user to encrypt a primary key and a secondary key to produce a first encrypted data and a second encrypted data, respectively, according to a program code stored in a memory medium of the secured storage device. The primary key is used to encrypt or decrypt user data, and the secondary key is used to protect the primary key by verifying whether a password inputted by user is identical to the user key. The secondary key, the first encrypted data, and the second encrypted data are stored in the secured storage device, while the primary key and the user key are not stored in the secured storage device. When a user intends to access user data stored in the secured storage device, according to the program code stored in the memory medium, the secured storage device requests the user to input a password and uses the password to decrypt the second encrypted data to produce a result of decryption. If the result of decryption is equal to the secondary key, it means that the password inputted by the user is identical to the user key and the password is further used to decrypt the first encrypted data to retrieve the primary key for decrypting or encrypting user data.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a diagram to illustrate the basic concept of symmetric-key algorithms;

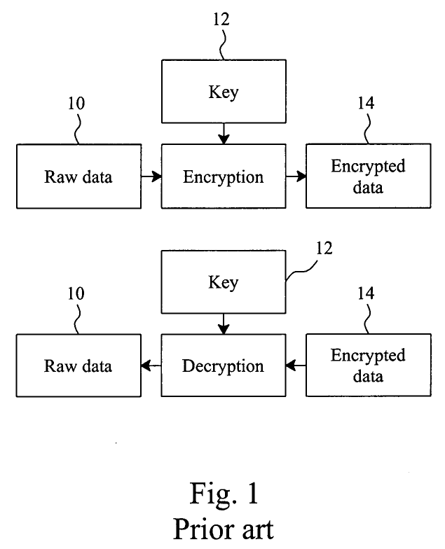

FIG. 2 is a block diagram of a secured USB storage device according to the present invention;

FIG. 3 is a diagram to illustrate an initialization of the secured USB storage device shown in FIG. 2; and

FIG. 4 is a flowchart in a process of password checking and primary key regeneration.

### DETAIL DESCRIPTION OF THE INVENTION

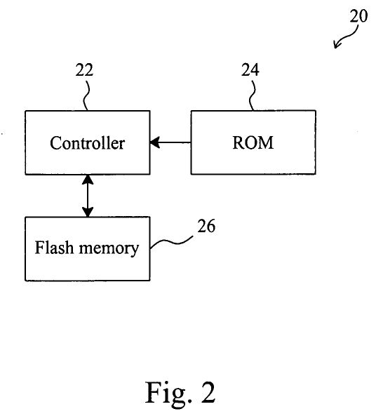

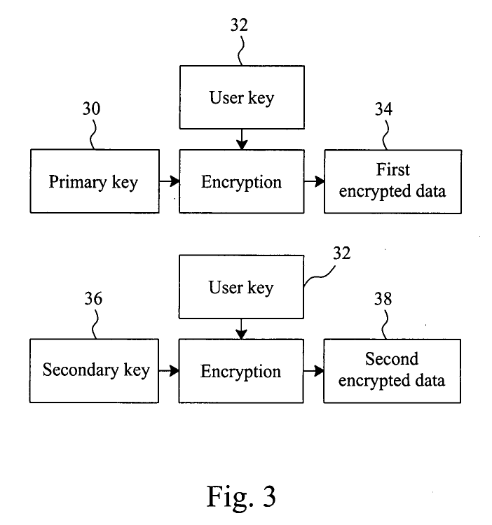

As shown in FIG. 2, a secured storage device 20 includes a controller 22 coupled to a read-only memory (ROM) 24 and a flash memory 26. The ROM 24 stores a program code and according to this program code, the controller 22 may access data stored in the flash memory 26. FIG. 3 is a diagram to illustrate an initialization of the secured USB storage device 20, which will have the controller 22 to execute the following steps according to the program code in the ROM 24. To begin with, a primary key 30 is automatically generated by the controller 22 in a random or any other manner, which may be an alphanumeric string. The primary key 30 is then treated as data to be encrypted with a user key 32 set by user to produce an encrypted data, namely first encrypted data 34. The first encrypted data 34 will be stored in the secured storage device 20, for instance, in the flash memory 26. On the other hand, a secondary key 36, for example the serial number allotted to the secured storage device 20 at the time it was manufactured, is also treated as data to be encrypted with the user key 32 to produce another encrypted data, namely second encrypted data 38. The secondary key 36 and the second encrypted data 38 are also stored in the flash memory 26 of the secured storage device 20. In other embodiments, the secondary key 36 may be replaced by any other alphanumeric string.

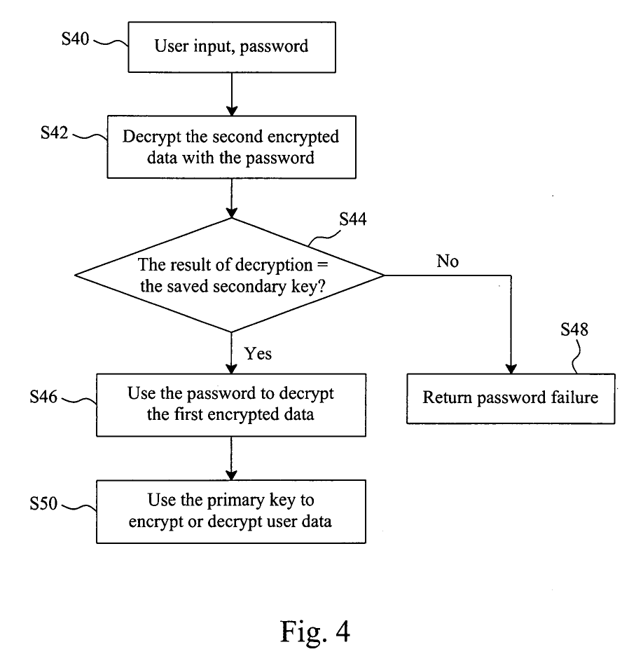

FIG. 4 is a flowchart in a process of password checking and primary key regeneration. After the security of the secured storage device 20 is enabled, part or all of user data stored in the secured storage device 20 is locked. In response to a user's request for accessing the locked data in the secured storage device 20, the controller 22 executes the program code in the ROM 24 and asks the user to input a password. After receiving the password in step S40, the secured storage device 20 uses the password to decrypt the second encrypted data 38 stored in the secured storage device 20 in step S42. Then, in step S44, the result of decryption is compared with the secondary key 36 stored in the secured storage device 20. If the result of decryption is equal to the saved secondary key 36, step S46 is executed so that the password is further used to decrypt the first encrypted data 34 stored in the secured storage device 20 to retrieve the primary key 30. Afterward, in step S50 the primary key 30 is used to decrypt or encrypt the user data to be read from or written into the secured storage device 20. If the result of decryption derived from the step S42 is different from the saved secondary key 36, the password is verified as incorrect, and step S48 is executed to return password failure.

The secured storage device 20 has the two-stage symmetric-key algorithm that involves two keys 30 and 32. The primary key 30 is used to encrypt/decrypt user data and the user key 32 is used to encrypt/decrypt the primary key 30. Neither the primary key 30 nor the user key 32 is stored in the secured storage device 20. The unique user key 32 is kept only by user. The secured storage device 20 only stores the first encrypted data 34, and the secondary key 36 and the second encrypted data 38 for verifying the password inputted by user. Consequently, even though the flash memory 26 is detached from the secured storage device 20 and maliciously invaded, the keys 30 and 32 are still secured against exposure. Moreover, whenever the user believes that the user key 32 risks divulgence, he can easily modify the user key 32 and perform the initialization shown in FIG. 3 again. Since files or user data stored in the secured storage device 20 are all encrypted with the primary key 30, modification of the user key 32 does not involve re-decrypting and re-encrypting all the stored files and user data. Only a small amount of data 34 and 38 that was encrypted with the user key 32 needs to be re-decrypted and re-encrypted. Hence, with the present invention, an encryption/decryption method that is efficient and reliable and allows keys thereof to be easily modified is accomplished.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A secured storage device comprising:
a first storage medium for storing a secondary key, a first encrypted data and a second encrypted data; and
a second storage medium for storing a program code with which the secured storage device may use a user key set by user to encrypt a primary key and the secondary key to produce the first encrypted data and the second encrypted data, wherein the primary key is for encryption or decryption of user data.

2. The secured storage device of claim 1, wherein the secondary key comprises a serial number allotted to the secured storage device when the secured storage device is manufactured.

3. The secured storage device of claim 1, wherein the secondary key comprises an alphanumeric string.

4. The secured storage device of claim 1, wherein the primary key comprises a randomly generated alphanumeric string.

5. A secured storage device comprising:
a first storage medium for storing a secondary key, a first encrypted data and a second encrypted data; and
a second storage medium for storing a program code with which the secured storage device may use a password inputted by user to decrypt the second encrypted data to produce a result of decryption to be compared with the secondary key, and if the result of decryption is identical to the secondary key, the password is further used to decrypt the first encrypted data to produce a primary key for encryption or decryption of user data.

6. The secured storage device of claim 5, wherein the secondary key comprises a serial number allotted to the secured storage device when the secured storage device is manufactured.

7. The secured storage device of claim 5, wherein the secondary key comprises an alphanumeric string.

8. The secured storage device of claim 5, wherein the primary key comprises an alphanumeric string.

9. A storage medium for a secured storage device, the storage medium comprising a program code for executing the steps of:
using a user key set by user to encrypt a primary key to produce a first encrypted data;
storing the first encrypted data in the secured storage device;
using the user key to encrypt a secondary key to produce a second encrypted data; and
storing the secondary key and the second encrypted data in the secured storage device;
wherein the primary key is for encryption or decryption of user data.

10. The storage medium of claim 9, wherein the program code comprises a part for executing the step of setting the secondary key.

11. The storage medium of claim 9, wherein the secondary key comprises a serial number allotted to the secured storage device when the secured storage device is manufactured.

12. The storage medium of claim 9, wherein the secondary key comprises an alphanumeric string.

13. The storage medium of claim 9, wherein the primary key comprises a randomly generated alphanumeric string.

14. A storage medium for a secured storage device, the storage medium comprising a program code for executing the steps of:
verifying whether a password inputted by user is correct; and
if the password is verified as correct, using the password to decrypt an encrypted data to produce a primary key for encryption or decryption of user data.

15. The storage medium of claim 14, wherein the step of verifying whether a password inputted by user is correct comprises the steps of:
using the password to decrypt a second encrypted data to produce a result of decryption; and
comparing the result of decryption with a secondary key previously stored in the secured storage device; and
if the result of decryption is identical to the secondary key, verifying the password is correct.

16. The storage medium of claim 15, wherein the secondary key comprises a serial number allotted to the secured storage device when the secured storage device is manufactured.

17. The storage medium of claim 15, wherein the secondary key comprises an alphanumeric string.

18. The storage medium of claim 14, wherein the primary key comprises an alphanumeric string.
